(19) United States
(12) Patent Application Publication
(10) Pub. No.: US 2007/0141504 A1
(43) Pub. Date: Jun. 21, 2007

(54) Liquid developer

(75) Inventor: Nobuhiro Miyakawa, Nagano-Ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION

(21) Appl. No.: 11/447,481

(22) Filed: Jun. 5, 2006

(30) Foreign Application Priority Data
Jun. 6, 2005 (JP) 2005-165091
Jun. 6, 2005 (JP) 2005-165092
Jun. 1, 2006 (JP) 2006-152998
Jun. 1, 2006 (JP) 2006-152999

(51) Int. Cl. G03G 9/125

(52) U.S. Cl. 430/115; 430/116; 430/137.19; 430/137.22

(57) ABSTRACT

The invention provides a liquid developer using a vegetable oil as a carrier solution, wherein a coloring agent for the carrier solution includes a benzimidazole pigment represented by chemical formula 1 and is positively chargeable. 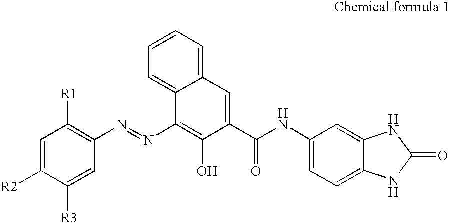
Here R1 is OCH₃, COOCH₃ or COOC₄H₉(n), R2 is NO₂, H, CONHC₆H₅ or SO₂NHR where R is an alkyl group represented by CₙH₂ₙ₊₁ provided that n is an integer of 1 to 4, and R3 is H, CH₃ or OCH₃.

### CROSS-REFERENCE TO RELATED APPLICATIONS

This application is based upon and claims the benefit of priority from prior Japanese Patent Application No. 2005-165091, filed on June 6, the entire contents of which are incorporated herein by reference.

### BACKGROUND

1. Technical Field

The present invention relates to a liquid developer used with an electrophotographic imaging system incorporated in copiers, printers, etc.

2. Related Art

An imaging system using a liquid developer has the feature of being capable of forming high-definition images without problems arising from scattering of toner particles leaving the system even in the case where fine toner particles are used. An electrophotographic imaging system using a liquid developer makes use of a developer in which a toner composed primarily of a coloring agent and a resin is dispersed in a carrier solution.

After developing an electrostatic latent image formed by exposure on a photosensitive material with the liquid developer, the ensuing toner image is transferred and fixed onto a recording medium such as paper for image formation.

For wet developers, petrolic volatile hydrocarbon-base solvents have been commonly used. The volatile hydrocarbon-base solvents are each a stable substance having a low electric conductivity. However, when a toner transferred or recorded on a recording medium is fixed, it is required to volatilize or evaporate the volatile hydrocarbon-base organic solvent from a carrier solution. The volatile hydrocarbon-base organic solvent used as the carrier solution has had a risk of environmental pollutions upon discharge.

To take care of the environment involved, it is necessary to locate neara fixing device recovery means for gases from the evaporation or volatilization of the carrier solution. However, that carrier solution recovery means has worked against downsizing, because it inevitably renders the imaging system bulky.

It has also been proposed to use a nonvolatile silicone oil or fluid paraffin for the carrier solution, thereby preventing evaporation or volatilization of the carrier solution. However, the carrier solution, because of being stable, continues to exist on the recording medium even after fixation, offering some problems such as poor drape and hand of print quality, a decreased marking capability due to the presence of the carrier solution on the surface of paper, and inferior writing capability of writing utensils using aqueous ink.

When a conventional liquid developer is produced, the respective components are used in the form of a non-aqueous non-polar solvent dispersion. Although depending on the nature of that non-polar solvent, however, there is still much left to be desired about system size, printing quality, and liquid developer's storage stability.

On the other hand, a lot more proposals have been put forward about using vegetable oils as carrier solutions instead of using volatile hydrocarbon-base organic solvents. Typically, JP-A-2000-19787 is an example of the related art. That related art alleges that using vegetable oils for a liquid developer carrier solution makes particles finer and odorless, and image density, resolution and fixability higher.

From electrophoretic observation of the polarity of a positively charging liquid developer prepared by dispersing a magenta pigment in a vegetable oil carrier solution, however, it has been found that any magenta colored image of sufficient density can never be formed because the magenta pigment is charged to both positive and negative polarities.

So far in the art, the use of a charge control agent (CCA) has been considered to be inevitable for the purpose of positively charging magenta pigments. With the amount of the charge control agent added growing large, however, it has been found that the storability of the dispersion becomes unstable. Especially with a liquid metal soap, it has been found that there is difficulty in allowing the liquid developer to perform its own function, because during long-term storage, there is an increase in the viscosity of the dispersion due to the polymerization, etc. of the vegetable oil in the carrier solution.

An advange of some aspects of the invention is to provide a positively charging liquid developer using a vegetable oil for a carrier solution, which contains no charge control agent or allows a charge control agent to be added to it in a reduced amount, and which is much more improved in terms of storage stability.

Another advange of some aspects of the invention is to provide a liquid developer in which the primary particle diameter upon dispersion of coloring pigment fine particles is small; the pigment itself is susceptible to charge positively in the vegetable oil; with the addition of a positive charge control agent, it is possible to get hold of control to positive polarity; the amount of fogging toner on a photosensitive material can be reduced; and cleaning is possible simultaneously with development.

### SUMMARY

An advange of some aspects of the invention is accomplishable by the provision of a liquid developer using a vegetable oil as a carrier solution, wherein a coloring agent includes a benzimidazole pigment represented by chemical formula 1 and is positively chargeable.

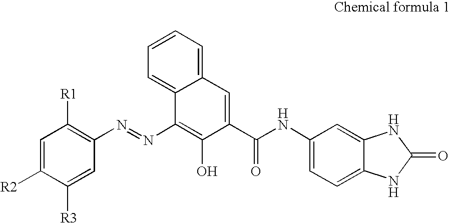

Here R1 is OCH₃, COOCH₃ or COOC₄H₉(n), R2 is NO₂, H, CONHC₆H₅ or SO₂NHR where R is an alkyl group represented by CₙH₂ₙ₊₁ provided that n is an integer of 1 to 4, and R3 is H, CH₃ or OCH₃.

In the above liquid developer, the coloring agent may contain a benzimidazole pigment that is either Pigment Red V32 represented by the following chemical formula 1-1 or Pigment Red 185 represented by the following chemical formula 1-2.

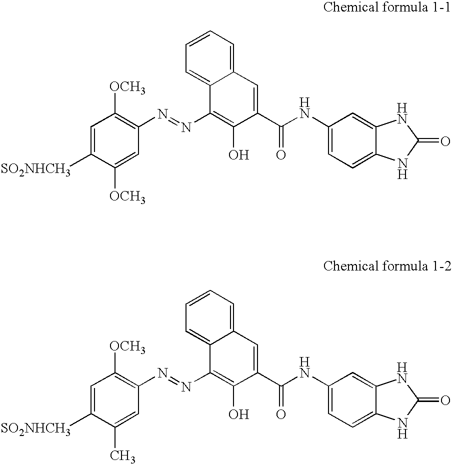

In the above liquid developer, the coloring agent may contain at least one benzimidazole pigment selected from the group consisting of Pigment Red 171 represented by the following formula 2-1, Pigment Red 175 represented by the following formula 2-2, Pigment Red 176 represented by the following formula 2-3, and Pigment Red 208 represented by the following formual 2-4.

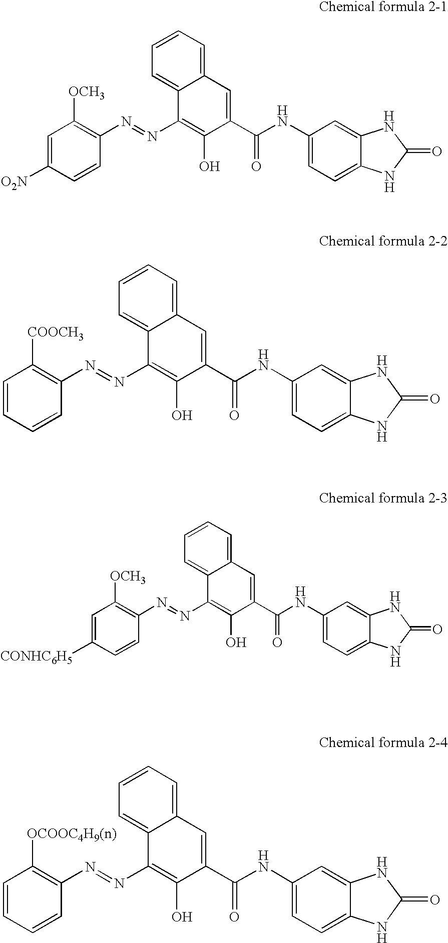

The invention also provides a liquid developer containing the above benzimidazole pigment and a charge control agent of positive polarity.

In the above liquid developer, the vegetable oil may be at least one selected from safflower oil, safflower seed oil, soybean oil, corn oil, cottonseed oil, rapeseed oil and linseed oil.

In the above liquid developer, the vegetable oil may be such that an oleic acid composition accounts for at least 60% by mass of triglyceride-forming fatty acids.

In the above liquid developer, the vegetable oil may be such that a linoleic acid composition accounts for at least 50% by mass of triglyceride-forming fatty acids.

In the above liquid developer, the vegetable oil may be such that a linolenic acid composition accounts for at least 50% by mass of triglyceride-forming fatty acids.

In the above liquid developer, the coloring fine particles dispersed in the vegetable oil have a primary particle diameter of up to 1 micrometer.

Further, the invention provides a process of producing a liquid developer containing a vegetable oil as a carrier solution, wherein the magenta pigment represented by either one of the aforesaid chemical formulae 1-1 and 1-2 is mixed with the vegetable oil, and the mixture is then dispersed by at least one dispersing/mixing means selected from a ball mill, a bead mill, a sand mill and an atritor.

Furthermore, the invention provides a process of producing a liquid developer containing a vegetable oil as a carrier solution, wherein the magenta pigment represented by any one of the aforesaid chemical formulae 2-1 to 2-4 is mixed with the vegetable oil and a charge control agent of positive polarity, and the mixture is then dispersed by at least one dispersing/mixing means selected from a ball mill, a bead mill, a sand mill and an atritor.

The above liquid developer may contain a charge control agent of positive polarity comprising an organic titanate compound.

### BRIEF DESCRIPTION OF THE DRAWINGS

The invention will be described with reference to the accompanying drawings, wherein like numbers reference like elements.

FIG. 1A is a perspective view illustrative of a measuring cell for the charge capability of the pigment dispersed in the vegetable oil according to the invention.

FIG. 1B is a perspective view illustrative of the electrode portion of the measuring cell for the charge capability of the pigment dispersed in the vegetable oil according to the invention.

FIG. 2A is a photomicrograph indicative an initial state of dispersion of a dispersion sample in an example.

FIG. 2B is a photomicrograph indicative of a state 90 minutes after dispersion of the dispersion sample in the example.

FIG. 2C is a photomicrograph indicative of a state 210 minutes after dispersion of the dispersion sample in the example.

FIG. 2D is a photomicrograph indicative of a state 450 minutes after dispersion of the dispersion sample in the example.

FIG. 2E is a photomicrograph indicative of a state 840 minutes after dispersion of the dispersion sample in the example.

FIG. 3 is illustrative of relations of electro-phoretic agglomerated particle diameter to the reflection densities of positive and negative toners.

FIG. 4A is a photomicrograph indicative of a state 450 minutes after dispersion of a dispersion sample in another example.

FIG. 4B is a photomicrograph indicative of a state 840 minutes after dispersion of the dispersion sample in another example.

FIG. 5 is illustrative of an imaging system in a liquid development mode.

### DESCRIPTION OF EXEMPLARY EMBODIMENTS

According to the invention, in a positively charging liquid developer using a vegetable oil as a carrier solution, what is going on with the charge capability of a pigment is studied when a charge control agent is added to it. It is consequently found that there is good positive charging capability obtained with a specific pigment, thereby overcoming the problem with a liquid developer, i.e., poor storability.

From studies of the charge capability of a pigment used with a positively charging liquid developer with a vegetable oil used as a carrier solution, it has been considered that the use of a large amount of charge control agent is inevitable to positively charge it. According to the invention, however, it has now been found that without recourse to any charge control agent or by addition of a very limited amount of charge control agent, a specific pigment is allowed to have good positive charge capability and good storage stability as well.

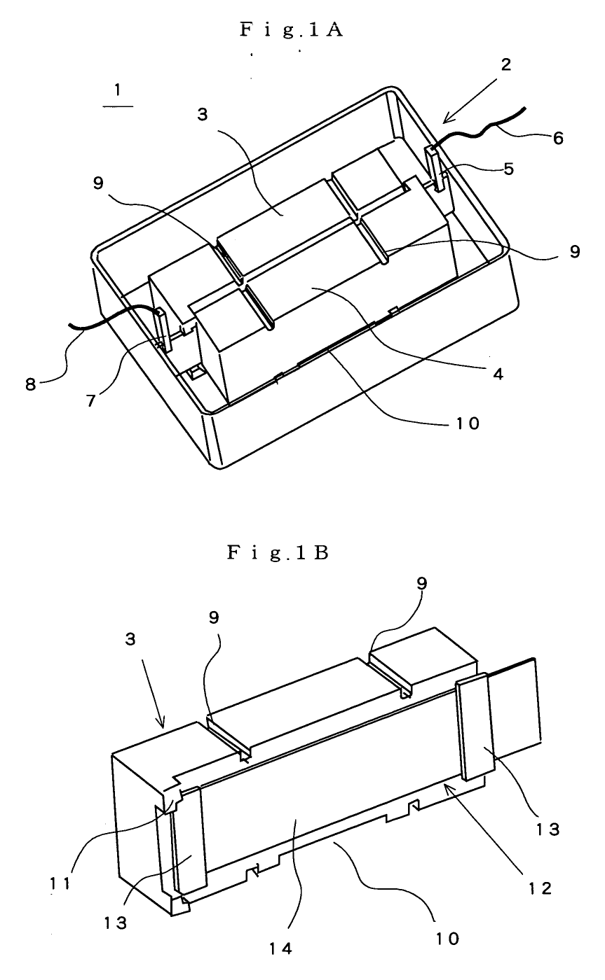

A measuring cell 1 for the charge capability of a pigment dispersed in a vegetable oil, shown in FIGS. 1A and 1B, has an anode-side electrode portion 3 and a cathode-side electrode portion 4 located in a casing 2 made up of an electric insulating material such as synthetic resin.

An anode terminal 5 provided at the anode-side electrode portion 3 is connected with a power supply anode-side lead wire 6 coupled to a current feeder(not shown), and a cathode terminal 7 provided at the cathode-side electrode portion 4 is connected with a cathode-side lead wire 8 coupled to a current feeder (not shown).

In the upper sites of the anode-side electrode portion 3 and cathode-side electrode portion 4, there are holder mounting grooves 9 provided to hold both the electrodes at a given space. By mounting the holder in the grooves, both the electrode portions are held at a given space during measurement.

In the lower sites of the anode electrode portion 3 and cathode electrode portion 4, there is a groove 10 provided to ensure a smooth feed of the pigment dispersion.

The anode electrode portion is now explained with reference to FIG. 1B. Note here that the cathode electrode portion, too, has a similar structure and members.

For the anode electrode portion 3, a molded member of a resin having high oil resistance and high solvent resistance such as polyacetal (polyoxymethylene) provided with an anode engagement protrusion 11 is used.

The anode engagement protrusion 11 is provided with an anode 12 along with a spacer 13 that keeps its space with the opposite electrode constant and is made up of an insulating material.

Preferably, the anode 12 is formed of a transparent glass plate having on it an ITO or other transparent, electrically conductive film 14 which is not susceptible to dissolution, etc. by applied currents. By using the anode comprising the transparent, electrically conductive film formed on the transparent glass plate, it is possible to provide easy optical observation and measurement of a pigment deposited onto the anode that is removed from the anode electrode portion after electrophoresis by current conduction for a given time.

Alternatively, the anode removed from the anode electrode portion may be pressed against a transfer material such as paper or synthetic resin film to transfer the pigment onto it, after which the pigment density is measured by means of a reflection densitometer or the like.

The pigments deposited onto both the anode and the cathode or their transferred images are compared, so that whether they have been charged positively or negatively can be determined.

According to the method described above, the magenta pigment is dispersed, either alone or with a slight amount of the charge control agent, in the vegetable oil that is the carrier solution to measure its polarity by electrophoresis. As a result, it has been found that some magenta pigments exhibit good positive charge capability in the vegetable oil.

Specifically, the magenta pigment represented by the following chemical formula 1 is found to exhibit good positive charge capability.

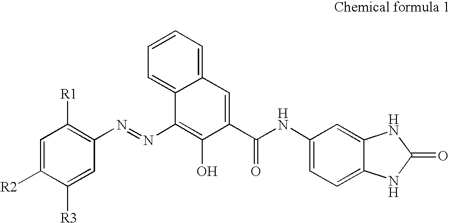

Here R1 is OCH₃, COOCH₃ or COOC₄H₉(n), R2 is NO₂, H, CONHC₆H₅ or SO₂NHR where R is an alkyl group represented by CnH₂ₙ₊₁ provided that n is an integer of 1 to 4, and R₃ is H, CH₃ or OCH₃.

In the liquid developer of the invention, the coloring agent may contain a benzimidazole pigment that is either Pigment Red V32 represented by the following chemical formula 1-1 or Pigment Red 185 represented by the following chemical formula 1-2.

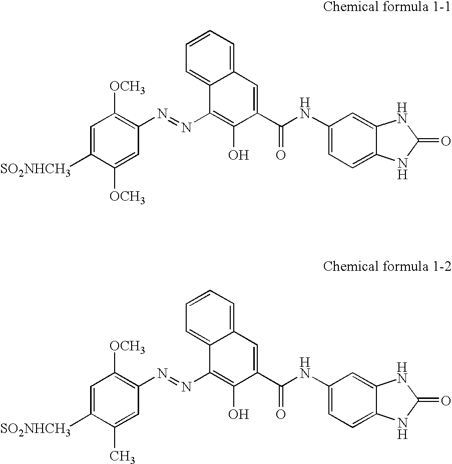

The invention also provides a liquid developer containing the aforesaid benzimidazole pigment and a charge control agent of positive polarity.

In the liquid developer of the invention, the coloring agent may contain at least one benzimidazole pigment selected from Pigment Red 171 represented by the following formula 2-1, Pigment Red 175 represented by the following formula 2-2, Pigment Red 176 represented by the following formula 2-3, and Pigment Red 208 represented by the following formula 2-4.

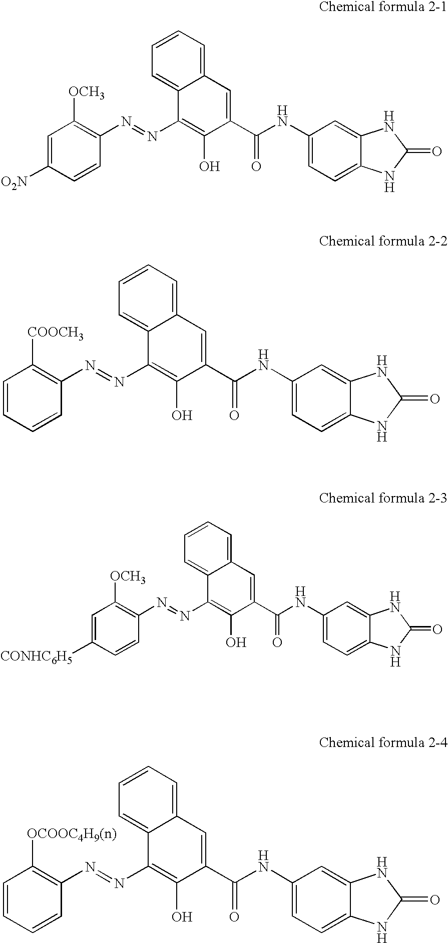

The vegetable oil usable with the liquid developer of the invention, for instance, include safflower oil, safflower seed oil, soybean oil, corn oil, cottonseed oil, rapeseed oil, and linseed oil.

Fats and oils are esters of one molecular of glycerin and three molecules of a fatty acid, that is, triglycerides. It is known that by allowing an alcohol or fatty acid to react with triglyceride, there is an ester interchange oil obtained, in which the raw fat and oil is denatured. The vegetable oil used here includes ester interchange oils produced from the raw vegetable oil by ester interchange. Vegetable oils may be used alone or in admixture of two or more, and esters obtained by decomposition of vegetable oils may be used as well.

Exemplary triglyceride compositions in the vegetable oils used with the liquid developer of the invention are set out in Table 1-1, wherein the unsaturated fatty acid compositions of oleic acid, linoleic acid and linolenic acid in the triglyceride-forming fatty acids are given by mass% with the names of unsaturated fatty acids.

Especially with triglycerides composed of fatty acid compositions having a large proportion of unsaturated bonds, such as oleic acid, linoleic acid, and linolenic acid, it is possible to dispense with, or simplify, fixing means, because they give rise to oxidative polymerization.

TABLE 1-1

| | Safflower Oil | Safflower Seed Oil | Soybean Oil |
|---|---|---|---|
| Oleic Acid | 13.9 | 28.6 | 23.3 |
| Linoleic Acid | 76.0 | 60.0 | 53.4 |
| Linolenic Acid | 0.2 | 0.3 | 7.0 |

| | | Cotton | | Lin |
|---|---|---|---|---|
| | Corn Oil | Seed Oil | Rape Seed Oil | Seed Oil |
| Oleic Acid | 32.2 | 19.3 | 62.7 | 20.2 |
| Linoleic Acid | 52.2 | 55.7 | 19.7 | 15.1 |
| Linolenic Acid | 1.0 | 0.8 | 8.8 | 56.2 |

Thus, the vegetable oil that is the carrier solution is preferably rape seed oil in which the oleic acid composition accounts for at least 60% by mass of the triglyceride-forming fatty acids.

Another vegetable oil that is the carrier solution preferably contains at least one of safflower oil, safflower seed oil, soybean oil, corn oil, and cotton seed oil, in which the linoleic acid composition account for at least 50% by mass of the triglyceride-forming fatty acids.

Yet another vegetable oil that is the carrier solution is preferably lin seed oil in which the linolenic acid composition accounts for at least 50% by mass of the triglyceride-forming fatty acids.

The liquid developer of the invention may include, together with the pigment, a charge control agent, a resin, an antioxidant or the like. Specifically, the charge control agent includes tetraethyltitanate, tetraisopropyl-titanate, tetra-n-propyltitanate, tetra-n-butyltitanate, tetra-tert-butyltitanate, tetra-2-ethylhexyltitanate, tetraoctyltitanate, tetramethoxytitanium, and titanium chelate such as titanylacetylacetate. Other examples are titanate coupling agents, e.g., isopropyltrisostearoyl-itanate, isopropyltridecylbenzenesulfonyltitanate, isopropyltris(dioctylpyrophosphate)titanate, tetraiso -propylbis(dioctylphosphite)titanate, tetraoctyl-bis(ditridecylphosphite)titanate, tetra(2,2-diallyloxydylmethyl-1-butyl)bis(di-tridecyl), bis(dioctyl-pyrophosphate)ethylenetitanate, isopropyltrioctanoyl-titanate, isopropyldimethacrylisostearoyltitanate, isopropylisostearoyldiacryltitanate, isopropyltri-(dioctylphosphate)titanate, isopropyltricumylphenyl-titanate, and isopropyltri(N-aminoethyl-aminoethyl) titanate.

For the binder resin, at least one or two or more selected from ethylene-vinyl acetate copolymers, polyester resins, styrene-acrylic resins, rosin modified resins, polyethylene, ethylene-acrylic acid copolymers, ethylene-maleic anhydride copolymers, polyvinyl pyridine, polyvinyl pyrrolidone, ethylene-methacrylic acid copolymers, and ethylene-acrylic ester copolymers may be used.

The antioxidants used, for instance, include dibutylhydroxyanisole, dibutylhydroxytoluene, tocophenol, L-ascorbic acid, erisorbic acid and catechin.

Preferably in the liquid developer of the invention, the vegetable oil, pigment, etc. are blended together, and dispersed by means of an atritor, a sandmill, a ball mill, a vibration mill or the like, thereby controlling the primary particle diameter of coloring fine particles to a number base average particle diameter of up to 1 micrometer.

### EXAMPLE 1-1

Liquid Developer Preparation 1

Charged in a stainless vessel of 500 ml in volume were 320 grams of zirconia balls of 5 mm in diameter, 100 grams of soybean oil, 0.11 gram of a dispersant (Ajispar PA111 made by Ajinomoto FineTechno) and 15 grams of benzimidazolone pigment: P. V. 32 represented by chemical formula 1-1, which were then dispersed and mixed at 504 rpm for 14 hours in an agitator (Tornado SM Type Propeller Agitation Blade made by Chuo Rikaki Seishakusho).

At the dispersion step, samples, each in an amount of 5 grams, were taken 1 minute, 90 minutes, 210 minutes and 450 minutes after the start of dispersion as well as after the lapse of 840 minutes at which agitation was over. Each dispersion sample, to which 30 grams of safflower seed oil were added, was irradiated with ultrasonic waves for 1 minute on an ultrasonic dispersing machine into a liquid developer.

Estimation of Pigment Particles at the Given Dispersing Time in the Bead Mill

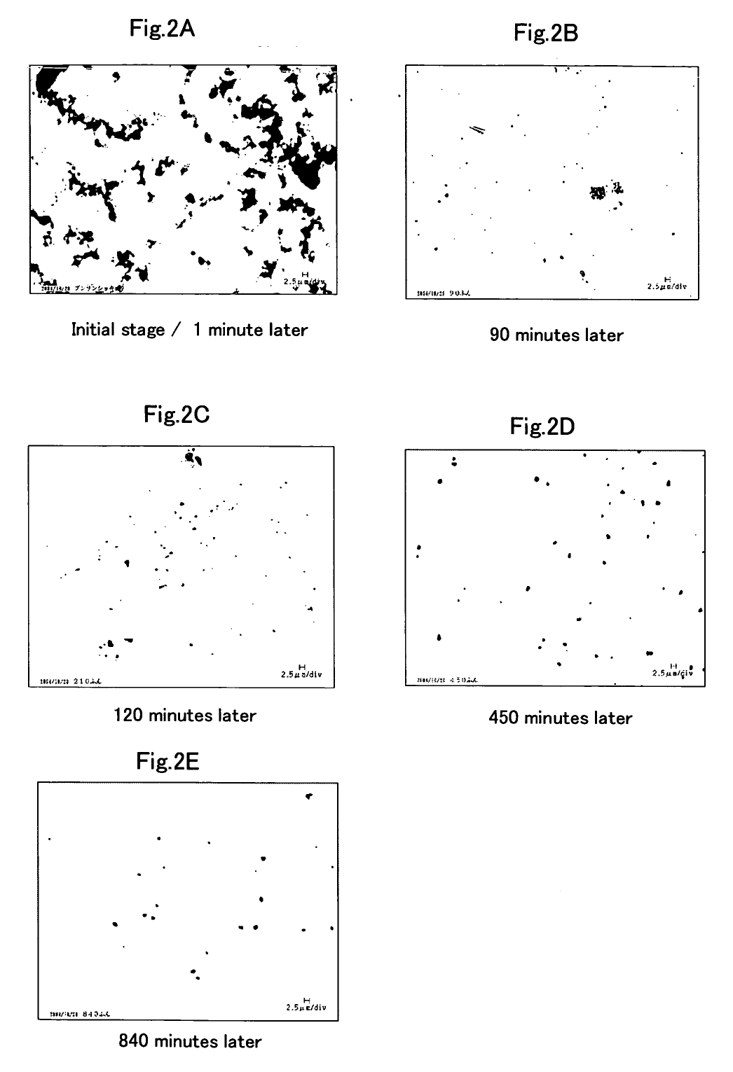

The dispersion samples taken at the predetermined points of time in the dispersion step were each deposited onto a slide glass in a slight amount, and a cover glass was then placed on it to make an estimation sample. A photograph of this estimation sample was taken at 2, 000 magnifications under a laser microscope (VH-7000 manufactured by KEYENCE). The results are attached hereto as FIGS. 2A to 2E.

Estimation of Charge Capability by Electrophoresis Using the charge capability measuring cell already explained with reference to FIGS. 1A and 1B, the charging behaviors of the pigment dispersions were examined. While a DC voltage of 300 V was applied to the charge capability measuring cell for 10 seconds with an inter-electrode distance set at 2 mm, coloring fine particles were deposited by electrophoresis onto the ITO transparent electrode. The ITO transparent electrode was removed off the measuring cell to transfer the coloring fine particles deposited onto the anode and cathode onto transfer paper (Top-Quality Paper J for PPC made by Fuji Xerox Office Supply) under pressure, so that the coloring fine particles deposited onto the respective electrodes could be obtained in the form of a colored solid image on the transfer paper.

After the obtained colored solid image was allowed to stand alone for 1 day, its density was measured as a reflection density, using a reflection densitometer (Model 520 Type Spectral Densitometer made by X-Rite). The amount of fine particles deposited onto the electrode can be estimated from the value of the reflection density on the transfer paper. That is, the reflection density on the cathode side being higher than that on the anode side indicates that the dispersed pigment fine particles are positively charged; the reflection density on the anode side being higher than that on the cathode side indicates that the dispersed pigment fine particles are negatively charged; and the same reflection density being observed on the anode side and the cathode side indicates that the dispersed pigment fine particles are neutrally charged.

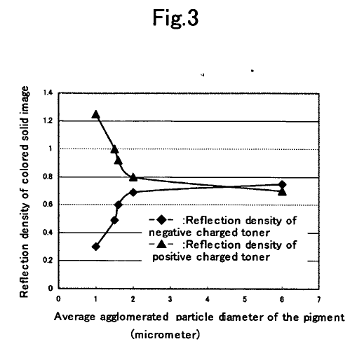

The results of these measurements are shown in FIG. 3. That is, correlations between the average particle diameters given by the maximum agglomerated particle diameters found from the photographs of FIGS. 2A to 2E and the reflection density readings on the reflection densitometer shown in FIG. 3 with the former as abscissa and the latter as ordinate. It has been found that as the agglomerated particle diameter of the pigment particles falls below 1 micrometer, there is a decrease in the fogging density with increasing image density.

Fifteen (15) grams of the benzimidazolone pigment: P. R. 185 represented by chemical formula 1-2 and 0.23 grams of a dispersant (Ajispar PN411 made by Ajinomoto FineTechno) were formulated into a liquid developer as in Example 1.

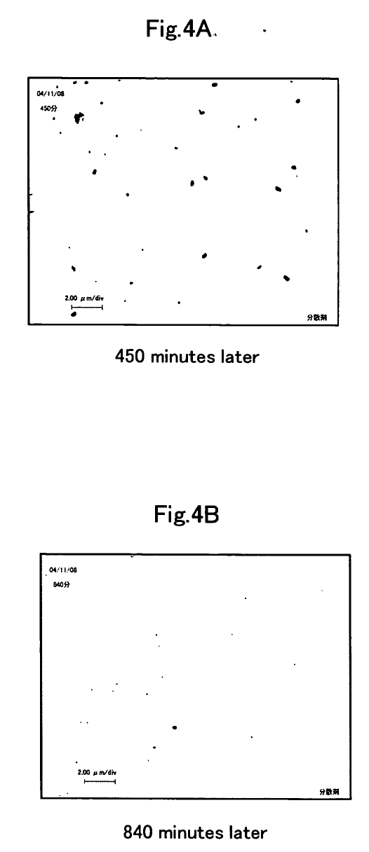

FIGS. 4A and 4B are photomicrographs taken, as in Example 1-1, of dispersion samples after the dispersing times of 450 minutes and 840 minutes.

A toner image deposited onto the anode side of the charge capability measuring cell, as in Example 1-1, was pressed against transfer paper, as in Example 1, and the reflection density of the obtained solid image was measured after allowed to stand alone for one day. The results are set out in Table 2.

TABLE 2

| | | | Reflection |
|---|---|---|---|
| | | Reflection Density | Density of |
| Dispersing | Mean Agglomerated | of Solid Image on | Solid Image on |
| Time | Particle Diameter | Cathode Side | Anode Side |
| 450 min. | 0.3 micrometer | 1.31 | 0.21 |
| 840 min. | 0.1 micrometer | 0.99 | 0.19 |

The above results indicate that as the agglomerated particle diameter of pigment particles becomes as small as about 0.1 micrometer, the hiding power defined as the pigment concentration tends to become weak; a pigment agglomerated particle diameter of at least 0.1 micrometer or greater is preferable.

### EXAMPLE 1-3

Regarding typical vegetable oils, the contents of fatty acid compositions in the triglyceride-forming fatty acids are set out in Table 1-3 in mass % in accordance with the names of unsaturated fatty acids.

Regarding comparative vegetable oils, too, main components are set out in Table 1-4.

TABLE 1-3

| Fatty Acid | Linseed Oil | Safflower Oil | Safflower Seed Oil |
|---|---|---|---|
| Palmitic Acid | 5.3% | 6.4% | 5.9% |
| Stearic Acid | 3.2% | 2.2% | 3.7% |
| Oleic Acid | 20.2% | 13.9% | 28.6% |
| Linoleic Acid | 15.1% | 76.0% | 60.0% |
| Linolenic Acid | 56.2% | 0.2% | 0.3% |

| | | | | Cotton |
|---|---|---|---|---|
| Fatty Acid | Soybean | Oil Rape Seed | Oil Corn Oil | Seed Oild |
| Palmitic Acid | 10.1% | 4.4% | 11.3% | 19.8% |
| Stearic Acid | 4.2% | 2.2% | 1.9% | 2.4% |
| Oleic Acid | 23.7% | 61.6% | 32.2% | 19.3% |
| Linoleic Acid | 53.7% | 19.8% | 52.2% | 55.7% |
| Linolenic Acid | 7.5% | 8.5% | 1.0% | 0.8% |

TABLE 1-4

| Fatty Acid | Sesame Oil | Olive Oil |
|---|---|---|
| Palmitic Acid | 9.1% | 10.3% |
| Stearic Acid | 5.5% | 2.9% |
| Oleic Acid | 38.2% | 78.8% |
| Linoleic Acid | 44.4% | 5.9% |
| Linolenic Acid | 0.3% | 0.6% |

The vegetable oils set out in Table 1-3 were brushed on transfer papers (Top-Quality Paper J for PPC made by Fuji Xerox Office Supply), and then exposed directly to sunlight for 7 days to examine the degree of yellowing of the papers, the results of which are set out in Table 1-5. The degree of yellowing is given in terms of values obtained by measuring the colored surfaces of the papers on a reflection densitometer (Model 520 type Spectral Densitometer made by X-Rite).

Note here that the comparative vegetable oils were colored just upon transfer onto transfer papers, and after the papers were allowed to stand for one day, their reflection density readings were 0.29 for sesame oil and 0.19 for olive oil; direct exposure to sunlight testing was not done.

TABLE 1-5

| | Vegetable Oil | | |
|---|---|---|---|
| | | | Safflower Seed |
| | Linseed Oil | Safflower Oil | Oil |
| Degree of Yellowing | 0.26 | 0.22 | 0.22 |

| | Vegetable Oil | | | |
|---|---|---|---|---|
| | Soybean | | Oil Corn | Cottonseed |
| | Oil | Rape Seed | Oil | Oil |
| Degree of Yellowing | 0.21 | 0.18 | 0.20 | 0.21 |

The results of Table 1-5 indicate that linseed oil in which the triglyceride-forming fatty acids contain a lot more linolenic acid composition gives the highest degree of coloring, but other vegetable oils give more or less similar degrees.

Liquid Developer Preparation 1-2

Using 15 grams of the benzimidazolone P.R. 185 of chemical formula 2-1 used in Example 1-2 and 0.23 grams of a dispersant (Ajispar PN411 made by Ajinomoto FineTechno), with the addition to and mixing with them of 100 grams of oleic acid (made by Kanto Kagaku), a coloring pigment dispersion was prepared as in Example 1. The dispersing time was 450 minutes. This operation was performed seven times to prepare a total of 805 grams of a concentrated toner for the liquid developer. Of the concentrated toner, 80 grams were added to 200 grams of each of the vegetable oils referred to in Table 3, and the resulting product was irradiated with ultrasonic waves for 2 minutes with an ultrasonic dispersing machine to prepare a coloring agent dispersion as an individual liquid developer.

Image Estimation Testing

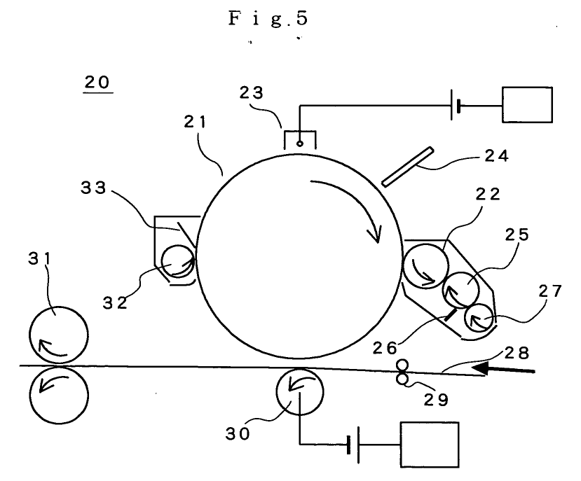

The thus prepared liquid developer was used for development, transfer, cleaning and fixation on an imaging system of the liquid development mode depicted in FIG. 5.

Referring to an imaging system 20, a single-layer type positively charged organic photosensitive material is used for a photosensitive material 21, and a developing roller 22 is built up of a resilient member. The photosensitive material 21 is first charged on the surface to +650 V using Scorotron 23, and a latent image is then formed by irradiation with laser light 24 controlled by image signals. Then, a developing bias of +600 V is applied to the developing roller 22 for development. A liquid developer is fed to the developing roller 22 that is rotated in contact with an Anirox roller 25 in the same direction while its layer thickness is limited by a limiting blade 26.

The liquid developer is supplied to the Anirox roller 25 from a feed roller 27 that is an elastic roller. With the transfer bias set at −950 V, transfer paper 28 is fed by a pair of feed rollers 29 at a speed of 200 mm/sec., as indicated by an arrow, while image transfer was in synchronism.

A transfer roller 30, built up of an elastic roller, is applied with a transfer bias by way of a control system. An image transferred onto the transfer paper passes between thermal fixing rollers 31, each built up of a water-repellent material, for fixation. The fixing temperature is set at 90° C., at which the developed and transferred toner image is unlikely to migrate into another member by way of contact.

When some toner remains after transfer, it is removed by an upper cleaning blade 33 while a cleaning elastic roller 32 in contact with the photosensitive material moves liquid developer depositions off the photosensitive material. The thus cleaned photosensitive material is repeatedly subjected to a cycle of charging-exposure-development-transfer-cleaning, thereby forming monochromatic images.

With the imaging system depicted in FIG. 5, 5% draft copy was used to produce solid image output using a liquid developer containing each of the vegetable oils mentioned in Table 1-3 as the carrier solution. For estimation of fixability, a 12 mm-wide adhesive tape (mending tape made by Sumitomo 3M) was applied over a printed image formed on transfer paper (Paper J for PPC made by Fuji Xerox Office Supply) and then peeled off to measure the density of an image remaining on the transfer paper and the density of the image before peeling-off using a reflection densitometer (made by X-Rite). The fixing ratio of the density of the remaining image to the density before peeling-off is set out in percentages in Table 1-6.

TABLE 1-6

| | Vegetable Oil | | |
|---|---|---|---|
| Density of Solid | Linseed Oil | Safflower Oil | Safflower Seed Oil |
| Image | 1.39 | 1.38 | 1.40 |
| Fixing Rate | 89% | 86% | 85% |

| | Vegetable Oil | | | |
|---|---|---|---|---|
| | | | | Cottonseed |
| Density of Solid | Soybean Oil | Rapeseed Oil | Corn Oil | Oil |
| Image | 1.37 | 1.43 | 1.41 | 1.36 |
| Fixing Rate | 86% | 80% | 83% | 84% |

The results of Table 1-6 indicate that in any case the fixing rate was at least 80%. Among others, the rapeseed oil in which the triglyceride-forming fatty acids contain a smaller amount of linoleic acid composition exhibited the lowest fixing rate, and the liquid developer containing a lot more linolenic acid composition having three unsaturated bonds exhibited the highest fixing rate. From these results, it has been found that the vegetable oil in which the triglyceride-forming fatty acids contain a lot more unsaturated fatty acid composition is excellent in fixability, and vegetable oils in which the linoleic or linolenic acid composition accounts for at least 50% by mass of the triglyceride-yielding fatty acids are excellent as a liquid developer carrier.

### EXAMPLE 2-1

Liquid Developer Preparation 2-1

Charged in a stainless vessel of 500 ml in volume were 320 grams of zirconia balls of 5 mm in diameter, 100 grams of soybean oil, 0.11 gram of a dispersant (Ajispar PA111 made by Ajinomoto FineTechno) and 15 grams of benzimidazolone pigment: P.R. 171 represented by chemical formula 2-1, which were then dispersed and mixed at 504 rpm for 14 hours in an agitator (Tornado SM Type Propeller Agitation Blade manufactured by Chuo Rikaki Seishakusho).

After the completion of the dispersion, 5 grams of a dispersion sample were taken, and then fully mixed with 30 grams of safflower seed oil.

Estimation of Charge Capability by Electrophoresis

Using the measuring cell for charge capability already explained with reference to FIGS. 1A and 1B, the charging behaviors of the pigment dispersions were examined. While a DC voltage of 300 V was applied to the charge capability measuring cell for 10 seconds with an inter-electrode distance set at 2 mm, coloring fine particles were deposited by electrophoresis onto the ITO transparent electrode. The ITO transparent electrode was removed off the measuring cell to transfer the coloring fine particles deposited onto the anode and cathode on transfer paper (Top-Quality Paper J for PPC made by Fuji Xerox Office Supply) under pressure, so that the coloring fine particles deposited on the respective electrodes could be obtained in the form of a colored solid image on the transfer paper.

After the obtained colored solid image was allowed to stand alone for 1 day, its density was measured as a reflection density, using a reflection densitometer (Model 520 Type Spectral Densitometer made by X-Rite). The amount of fine particles deposited on the electrode can be estimated from the value of the reflection density on the transfer paper. That is, the reflection density on the cathode side being higher than the reflection density on the anode side indicates that the dispersed pigment fine particles are positively charged; the reflection density on the anode side being higher than the reflection density on the cathode side indicates that the dispersed pigment fine particles are negatively charged; and the same reflection density being observed on the anode side and the cathode side indicates that the dispersed pigment fine particles are neutrally charged.

These results are set out in Table 2-1 with the positive charge capability as +, the negative charge capability as −, and the particles positively and negatively charged on much the same level as ±.

A similarly prepared liquid developer was added with 0.21 grams of titanium tetra-n-butoxy monomer as the charge control agent (CCA), followed by full agitation. Then, the charge capability of the coloring dispersion fine particles containing the charge control agent was similarly examined using the charge capability measuring cell. The results of measurement of the reflection densities of the solid images deposited on the cathode and anode sides are set out in Table 2-1.

For comparison purposes, similar experimentation was carried out using the compound known as Naphthol Red P.R. 112 and represented by the following chemical formula 2-5. The results are also set out in Table 2-1.

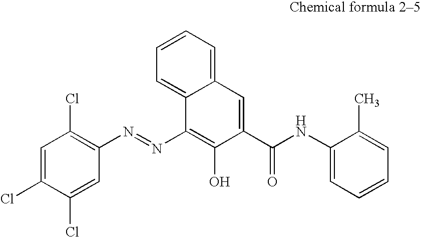

TABLE 2-1

| | Structural Formula | |
|---|---|---|
| | of Benzimidazolone | Polarity of Charged Coloring |
| Color Index | Pigment | Dispersion Fine Particles |
| P.R. 171 | Chemical Formula 2-1 | ± |
| P.R. 175 | Chemical Formula 2-2 | ± |
| P.R. 176 | Chemical Formula 2-3 | ± |
| P.R. 208 | Chemical Formula 2-4 | ± |
| P.R. 112 | Chemical Formula 2-5 | − |

Reflection Density of Solid Images Deposited
onto the Electrodes after the Addition of CCA

| Color Index | Cathode Side | Anode Side |
|---|---|---|
| P.R. 171 | 1.19 | 0.41 |
| P.R. 175 | 1.29 | 0.35 |
| P.R. 176 | 1.36 | 0.36 |
| P.R. 208 | 1.28 | 0.36 |
| P.R. 112 | 0.79 | 0.76 |

As can be understood from the results of Table 2-1, the benzimidazolone-base organic pigments represented by chemical formula 1 in general, and chemical formulae 2-1 to 2-4 in particular are charged to positive polarity by the addition to them of the charge control agent of positive polarity; however, even compounds having much the same basic skeleton as that of the benzimidazolone-base pigments represented by chemical formula 1 are charged substantially to neutrality, when they have a chlorine or other halogen atom in substituents, so that the amounts of coloring dispersion fine particles deposited onto the negative and anode sides are substantially the same.

### EXAMPLES 2-2 TO 2-9 AND COMPARATIVE EXAMPLE 1

Using an agitator (Tornado SM Type Propeller Agitation Blade made by Chuo Rikaki Seishakusho) as in Example 2-1, 100 grams of each of the vegetable oils mentioned in Table 1-3 wherein the compositions in the triglyceride-forming fatty acids are given as the types of fatty acids, 15 grams of each of the benzimidazolone pigments behaving as coloring agents and mentioned in Table 2-2, 0.21 grams of the charge control agent and 0.2 grams of the dispersant Ajispar PN411 made by Ajinomoto FineTechno were dispersed and mixed together at 504 rpm for 14 hours. After the completion of dispersion, 5 grams of a dispersion sample were taken, and then fully mixed with 30 grams of the vegetable oil used for dispersion.

By measurement under a laser microscope (VH-7000 made by KEYENCE), the agglomerated particle diameters of the coloring agents after the 14-hour dispersing operation were less than 1 micrometer in all the test runs.

Testing for estimation by electrophoresis was performed as in Example

2-1. The results are set out in Table 2-2.

As Comparative Example 1, a coloring dispersion was similarly prepared, using 0. 21 grams of an aluminum-base coupling agent (alkyl acetoacetate aluminum-diisopropylate).

TABLE 2-2

| | Structural Formula of | Added Charge |
|---|---|---|
| | Benzimidazolone | Control Agent (CCA) of |
| Ex. | Pigment | Positive Polarity |
| 2-2 | Chemical Formula 2-1 | Tetraethyltitanate |
| 2-3 | Chemical Formula 2-2 | Tetraisopropyltitanate |
| 2-4 | Chemical Formula 2-3 | Tetra-n-butyltitanate |
| 2-5 | Chemical Formula 2-4 | Tetra-2-ethylhexyltitanate |
| 2-6 | Chemical Formula 2-1 | Tetraoctyltitanate |
| 2-7 | Chemical Formula 2-2 | Isopropyltrioctanoyltitanate |
| 2-8 | Chemical Formula 2-3 | Isopropyltriisostearoyltitanate |
| 2-9 | Chemical Formula 2-4 | Isopropyltrioctanoyltitanate |
| CE 1 | Chemical Formula 2-5 | Aluminum-Base Coupling Agent |

Reflection Density

| Ex. | Vegetable Oil | Cathode Side | Anode Side |
|---|---|---|---|
| 2-2 | Linseed Oil | 1.19 | 0.41 |
| 2-3 | Safflower Oil | 1.29 | 0.35 |
| 2-4 | Safflower Seed Oil | 1.36 | 0.36 |
| 2-5 | Soybean Oil | 1.28 | 0.36 |
| 2-6 | Rape Seed Oil | 1.20 | 0.40 |
| 2-7 | Corn Oil | 1.27 | 0.33 |
| 2-8 | Cotton Seed Oil | 1.39 | 0.29 |
| 2-9 | Safflower Oil | 1.35 | 0.39 |
| CE 1 | Safflower Seed Oil | 0.63 | 0.69 |

CE 1: Comparative Example 1

The results of Table 2-2 indicate that the addition of the charge control agents that are the organic titanate compounds of positive polarity ensures that the dispersed coloring fine particles are positively charged in each test run, but in Comparative Example 1 with the addition of the aluminum-base coupling agent, the amount of depositions on the negative electrode side is nearly identical to that on the positive electrode; the comparative sample is estimated to be nearly neutral from the standpoint of a liquid developer.

It follows that when the vegetable oil is used as the carrier solution, a liquid developer chargeable to positive polarity is obtainable by the addition of an organic titanate compound to a specific pigment equally charged to bipolarity, positive and negative.

In the invention, reducing the agglomerated particle diameter of the dispersed coloring fine particles down to 1 micrometer or less works effectively, yet 100 nm or greater is preferable.

To confirm this, the dispersion coloring agent of Example 2-4 was pulverized and dispersed fro 24 hours, and then finely pulverized to the primaryparticle diameter of less than 100 nm. By similar measurement of solid image densities obtained by transferring depositions against transfer paper under pressure, said depositions being obtained by electrophoretic migration to the anode and cathode, it has been found that the densities of solid images deposited on the negative electrode side and the positive electrode side are 1.09 and 0. 31, respectively, indicating that too fine particles tend to give rise to a decrease in the hiding power.

### EXAMPLE 2-10

Image Estimation Testing

Using the imaging system of the liquid development mode depicted in FIG. 2, imaging tests were carried out as in Example 1-3 to make estimation of image characteristics.

The results are set out in Table 2-3.

TABLE 2-3

| | Vegetable Oil | | |
|---|---|---|---|
| Density of Solid | Linseed Oil | Safflower Oil | Safflower Seed Oil |
| Image | 1.41 | 1.43 | 1.46 |
| Fixing Rate | 86% | 83% | 82% |

| | Vegetable Oil | | | |
|---|---|---|---|---|
| | | | | Cotton Seed |
| Density of Solid | Soybean Oil | Rape Seed | Oil Corn Oil | Oil |
| Image | 1.41 | 1.45 | 1.42 | 1.39 |
| Fixing Rate | 85% | 80% | 81% | 82% |

The results of Table 2-3 indicate that in any case the fixing rate was at least 80%. Among others, the rapeseed oil wherein the triglyceride-forming fatty acids contain a smaller amount of linoleic acid composition exhibited the lowest fixing rate, and the liquid developer containing a lot more linolenic acid composition having three unsaturated bonds exhibited the highest fixing rate. From these results, it has been found that the vegetable oil wherein the triglyceride-forming fatty acids contain a lot more unsaturated fatty acid composition is excellent in fixability, and vegetable oils wherein the linoleic or linolenic acid composition accounts for at least 50% by mass of the triglyceride-yielding fatty acids are excellent as a carrier for liquid developer.

Further, these liquid developers were allowed to stand alone at 25° C. for one month, and then again subjected to printing testing. From comparisons of the developers before and after allowed to stand alone for one month, there was no change found.

The invention provides a positively chargeable liquid developer using a vegetable oil for a carrier solution, wherein a specific, well-dispersible imidazolone pigment is used as a pigment, so that without recourse to a charge control agent or with the use of it in a very limited amount, a full dispersion state is achievable. It is thus possible to provide a liquid developer that is improved in terms of storage stability without causing problems such as polymerization occurring where a charge control agent is added thereto, especially where it is added in large amounts.

Especially with the vegetable oil in which the triglyceride-forming fatty acids contain a lot more linoleic or linolenic acid composition, it is possible to provide an imaging system with a simplified fixing means or without any fixing means whatsoever, because a toner image formed by the developer or the carrier solution is in itself polymerized by oxidization to fix the toner image in place.

Even when acidic paper is used for a recording medium, the pigment used, because of taking on basicity, acts in a direction of neutralizing the pH of the paper, so that the storage stability of the recorded images can be improved. Further, the acid of the acidic paper allows the vegetable oil depositions to act as a polymerization-by-oxidization catalyst.

Further, the dispersed primary particle diameter of the coloring pigment fine particles being 1 micrometer or less ensures that the pigment is easily positively charged in the vegetable oil, and the addition of the charge control agent ensures that the pigment is controllable to positive polarity, and the amount of fogging toner on a photosensitive material decreases, making cleaning simultaneously with development possible.

What is claimed is:

1. A liquid developer using a vegetable oil as a carrier solution, characterized in that a coloring agent includes a benzimidazole pigment represented by chemical formula 1 and is positively chargeable. 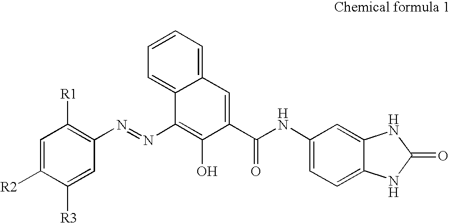
where R1 is OCH₃, COOCH₃ or COOC₄H₉(n), R2 is NO₂, H, CONHC₆H₅ or SO₂NHR where R is an alkyl group represented by CnH₂ₙ₊₁ provided that n is an integer of 1 to4, and R3 is H, CH₃ or OCH₃.

2. A liquid developer as recited in claim 1, wherein the coloring agent contains a benzimidazole pigment that is either Pigment Red V32 represented by the following chemical formula 1-1 or Pigment Red 185 represented by the following chemical formula 1-2.

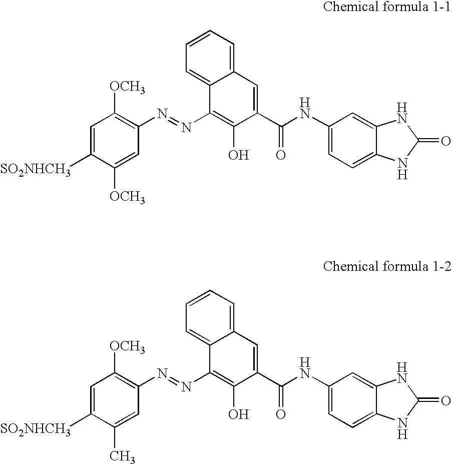

3. A liquid developer as recited in claim 1, wherein the coloring agent contains at least one benzimidazole pigment selected from the group consisting of Pigment Red 171 represented by the following chemical formula 2-1, Pigment Red 175 represented by the following chemical formula 2-2, Pigment Red 176 represented by the following chemical formula 2-3, and Pigment Red 208 represented by the following chemical formula 2-4.

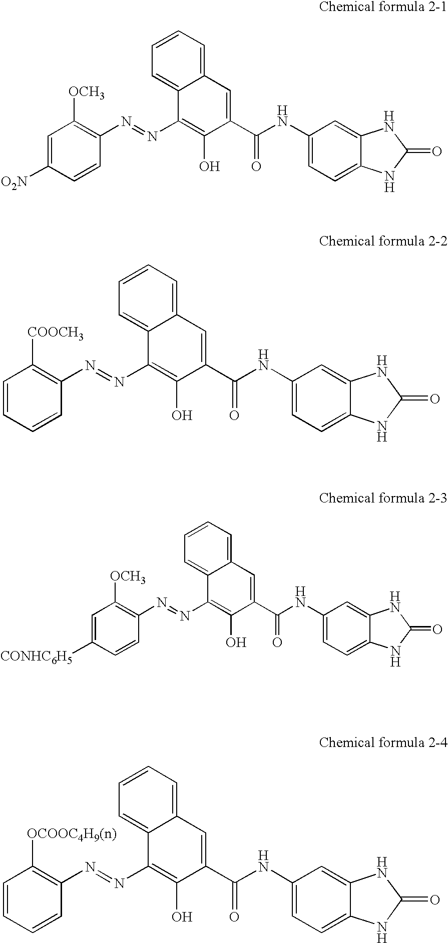

4. A liquid developer as recited in claim 3, characterized by containing a benzimidazole pigment and a charge control agent of positive polarity.

5. A liquid developer as recited in claim 4, characterized by containing a charge control agent of positive polarity, which comprises an organic titanate compound.

6. A liquid developer as recited in claim 1, characterized in that the primary particle diameter of coloring fine particles dispersed in the vegetable oil is at least 1 micrometer or less.

7. A liquid developer as recited in claim 1, characterized in that the vegetable oil comprises at least one selected from safflower oil, safflower seed oil, soybean oil, corn oil, cotton seed oil, rape seed oil and lin seed oil.

8. A liquid developer as recited in claim 6, characterized in that the vegetable oil is such that oleic acid accounts for 60% by mass or more of triglyceride-forming fatty acids.

9. A liquid developer as recited in claim 6, characterized in that the vegetable oil is such that linoleic acid accounts for 50% by mass or more of triglyceride-forming fatty acids.

10. A liquid developer as recited in claim 6, characterized in that the vegetable oil is such that linolenic acid accounts for 50% by mass or more of triglyceride-forming fatty acids.

11. A process of producing a liquid developer containing a vegetable oil as a carrier solution, characterized in that a magenta pigment represented by chemical formula 1, any one of chemical formulae 1-1 to 1-2, or any one of chemical formulae 2-1 to 2-4 is mixed with the vegetable oil, and then dispersed by at least one dispersing/mixing means selected from a ball mill, a bead mill, a sand mill, and an atritor: 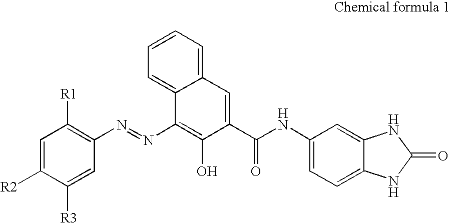
where R1 is OCH₃, COOCH₃ or COOC₄H₉(n), R2 is NO₂, H, CONHC₆H₅ or SO₂NHR where R is an alkyl group represented by CnH₂ₙ₊₁ provided that n is an integer of 1 to 4, and R3 is H, CH₃ or OCH₃.
